(19) United States
(12) Patent Application Publication
(10) Pub. No.: US 2013/0216107 A1
(43) Pub. Date: Aug. 22, 2013

(54) METHOD OF SURVEILLANCE BY FACE RECOGNITION

(71) Applicants: Chih-Hsung Huang, Taipei City (TW); Chen-Han Chu, Taipei City (TW)

(72) Inventors: Chih-Hsung Huang, Taipei City (TW); Chen-Han Chu, Taipei City (TW)

(21) Appl. No.: 13/400,120

(22) Filed: Feb. 20, 2012

(51) Int. Cl. G06K 9/00

(52) U.S. Cl. 382/118

(57) ABSTRACT

A method of surveillance by face recognition is disclosed. The method includes the steps of: first building up the face recognition database library in a storage medium comprising a plurality of face images; taking dynamic videos via an image capture device and showing the dynamic videos in the display device; performing face recognition to find the target face image in each dynamic video, and then determine the target face image as the matched or mismatched face image by comparing the target face image with the face images in the face recognition database library; and finally marking the matched and mismatched face images by different colored frames, respectively. Therefore, the method of the present invention can dynamically mark the target face images by images, colored frames and/or text to provide a solution of surveillance with high safety and efficiency.

### BACKGROUND OF THE INVENTION

1. Field of the Invention

The present invention generally relates to a method of surveillance, and more specifically to using face recognition to identify and mark the target face image.

2. The Prior Art

In general, entrance guard of specific scenes needs some on-site surveillance persons using a video camera to take pictures, and some monitoring operators in the remote site watching a monitor connected to the video camera and examining the pictures shown in the monitor for real-time monitoring. Once specific people such as terrorists, suspected criminals, or missing guys, appearing and found, those monitoring operators may take appropriate measures, such as closing the door to stop suspected people or pushing an alarm button to inform the guards to come over to deal with the situation.

However, one of the shortcomings in the prior arts is that on-site surveillance persons and monitoring operators all have to focus on taking pictures by video camera and examining the pictures in the monitor for a long time, respectively, and it is easy to cause vision fatigue for them, resulting in personal carelessness. Thus, safety for the specific scenes is seriously challenged.

Therefore, it is desired to provide a method of surveillance by face recognition along with suitable text or mark to solve the above-mentioned problems.

### SUMMARY OF THE INVENTION

To overcome the above-mentioned shortcomings in the prior arts, a method of surveillance by face recognition is provided. The method in accordance with the present invention comprises the steps of: first building up the face recognition database library in a storage medium comprising a plurality of face recognition data, each face recognition data at last comprising a face image and/or a name of a person previously recognized; taking dynamic videos and show the dynamic videos in the display device; performing face recognition by examining the face image in the dynamic videos and ascertaining the respective identity to identify the target and undetermined face images in the face recognition database library, wherein the target face image is matched with at least one of the face images in the face recognition library; and finally marking the target face image with the green frame showing his/her name, and the undetermined face image with the red frame.

Therefore, the method of the present invention can dynamically mark the target and undetermined face images by names and/or text to provide a solution of surveillance with high efficiency.

### BRIEF DESCRIPTION OF THE DRAWINGS

The present invention can be understood in more detail by reading the subsequent detailed description in conjunction with the examples and references made to the accompanying drawings, wherein:

FIG. 1 shows the flow chart to illustrate the processes of the method according to the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

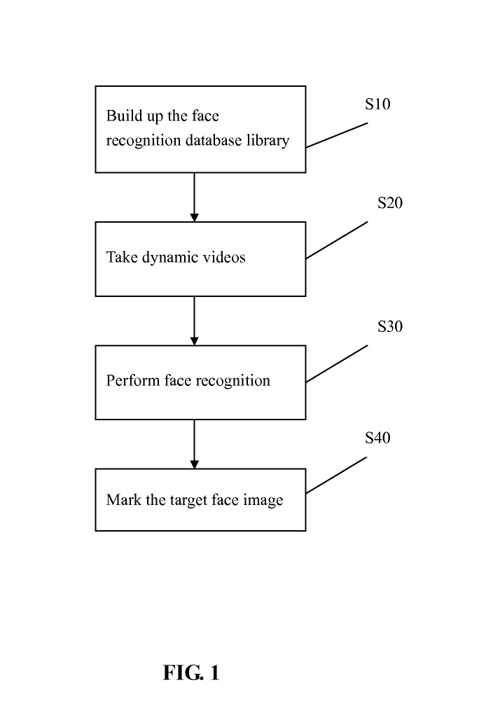

The flow chart to illustrate the processes of the method of surveillance by face recognition according to the present invention is depicted in FIG. 1. The method of the present invention comprises the steps S10 to S40 sequentially performed to assist on-site surveillants or guards and monitoring operators to real-time monitor entrance of people for specific scenes.

First, in the step S10, the method according to the present invention starts with building up a face recognition database library which is stored in a storage medium. The face recognition library comprises a plurality of face recognition data, and each face recognition data may comprises at least one of a face image, name, occupation, age, company, number of entering/leaving, and time of entering/leaving of the person previously recognized. The storage medium comprises at least one of solid state hard drive, hard drive, magnetic tape, and non-volatile memory, such as flash memory.

The above face images in the face recognition database library can be generated by taking pictures of human faces via a camera or video camera, or photos scanned by a scanning device, or by downloading through wire or wireless network.

Then, in the step S20, dynamic videos are taken of some specific site via an image capture device and shown in a display device. The image capture device can be a video camera, surveillance cameras or a device with an image sensor.

In the step S30, face recognition is performed to examine the dynamic videos displayed in the display device. The face recognition comprises: finding at least a face image with part of human face characteristics in each dynamic videos as a target face image; and identifying the target face image by a first or second identification process based on an identification option selected.

The above first identification process is to determine the target face image a matched or mismatched face image by comparing the target face image with the face images in the face recognition database library. Specifically, if the target face image matches one of the face images in the face recognition database library, the target face image is determined as the matched face image; or if the target face image does not match any face image in the face recognition database library, the target face image is determined as the mismatched face image.

The second identification process is to find a plurality of similar face images in the face recognition database library, which similarly match the target face image, and the most similar face image is determined as the qualified matched target face image. For example, if five similar face images are found for the target face, the most similar face image to the target face is the matched face image. Therefore, in the second identification process, there is always a matched face image and no unqualified face image.

Finally, in the step S40, the target face image is marked in a first or second marking manner according to the first or second identification process used in the step 30, respectively.

In the first marking manner, the target face image determined as the matched face image in the first identification process is marked by a first colored frame with a first color, and the name of the person corresponding to the matched face image can also be displayed. And, the mismatched face image is marked by a second colored frame with a second color. The second color is selected to be different from the first color. For example, the first color is green and the second color is red.

Additionally, to further mark the matched face image, the occupation, age, company, number of entering/leaving, and time of entering/leaving of the person recognized/identified can also be displayed.

As for the target face image determined by the second identification process in the step 30, the second marking manner is used to mark the most similar target face image by a third colored frame with a third color which is different from the first and second colors, and to display the name of the person corresponding to the most similar face image, or all corresponding names of the plurality of similar face images found in the second identification process. Similarly, other information for the plurality of similar face images can be displayed for reference.

The step 40 of the method according to the present invention may further comprise an alarm and/or tracking process after said marking the target face image. The alarm and/or tracking process may comprise a step of triggering an alarm, sending an e-mail, sending a message via a mobile phone, and/or make a call via an alarm system for informing some related people, such as the surveillants or guards nearby. And, the alarm and/or tracking process may further comprise a step of tracking and marking the location of the target face image through a platform with a surveillance program or a three-dimensional spatial model.

The face recognition in the step S30, the process of marking target face image in the step S40 and other post processes can be implemented by executing a specific program with a single chip controller, computer, remote server or other electronic control devices.

Additionally, the face recognition data may further comprise a strict level for the face recognition to distinguish different levels of strictness desired in the step S30, or to select all or part of the face recognition data displayed in the step S40.

For example, the strict level can be specified as the high, medium, or low security. As for the high security, the face recognition will further determine if the dynamic videos are the video really taken from a real person or just photos, and all related information will be displayed, such as the occupation, age, company, number of entering/leaving, and time of entering/leaving for the identified/recognized person. For the medium security, both the first colored frame and the name of the identified/recognized person are shown, and for the low security, only the first colored frame is shown.

One of the features provided by the present invention is that the on-spot people for guard entrance can easily and clearly monitor the status of entering/leaving by examining the colored frames along with the text such as the name of the identified person shown in the display device. Therefore, the present invention can improve the efficiency of surveillance and reduce the loading of human resource, and is suitable for the gate of the factory, the entrance of large events, the area of big meetings, the door of the office, the airport, the harbor, the train/bus station, or the intersections of the specific roads.

Another feature provided by the present invention is that the face image and basic information of some specific people such as unwelcomed persons, terrorists, suspected criminals, or missing persons can be previously stored in the face recognition database library, and the face image and basic information can be shown in the display device to remind the surveillance people when specific people appear and are recognized/identified.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of surveillance by face recognition, comprising steps of:
building up a face recognition database library stored in a storage medium, wherein said face recognition database library comprises a plurality of face recognition data, each face recognition data at last comprising a face image and/or a name of a person previously recognized;
taking dynamic videos of a specific site via an image capturing device and showing the dynamic videos in a display device;
performing face recognition to examine the dynamic videos displayed in the display device, wherein said face recognition comprises steps of:
finding at least a face image with part of human face characteristics in each dynamic video as a target face image; and
identifying said target face image by a first or second identification process based on an identification option selected, wherein:
said first identification process is to determine said target face image is a matched face image if said target face image matches one of said face images in said face recognition database library, or to determine said target face image is a mismatched face image if said target face image does not match anyone of said face images in said face recognition database library; and
said second identification process is to find a plurality of similar face images in said face recognition database library, each similarly matching said target face image, and a most similar face image is determined as matched with said target face image; and
marking said target face image in a first or second marking manner according to said first or second identification process used, respectively, wherein:
said first marking manner is to mark said target face image as said matched face image determined in said first identification process by a first colored frame with a first color and to display said name of said person corresponding to said matched face image, and to mark said target face image as said mismatched face image determined in said first identification process by a second colored frame with a second color which is different from said first color; and
said second marking manner is to mark said target face image with said most similar face image in the plurality of similar face images by a third colored frame with a third color which is different from said first and second colors when said target face image is determined in said second identification process, and to display the name of said person corresponding to said most similar face image, or all corresponding names of the plurality of similar face images found in said second identification process.

2. The method as claimed in claim 1, wherein said storage medium comprises at least one of solid state hard drive, hard drive, magnetic tape, and non-volatile memory.

3. The method as claimed in claim 1, wherein said face recognition data further comprises at least one of occupation, age, company, number of entering/leaving, and time of entering/leaving for said person related to said matched face image, said most similar face image or said similar face images used to display in said display device to mark said matched face image, said most similar face image or said similar face images.

4. The method as claimed in claim 1, wherein said image capture device comprises a video camera or surveillance cameras.

5. The method as claimed in claim 1, wherein said first colored frame consists of green lines or curves, and said second colored frame consists of red lines or curves.

6. The method as claimed in claim 1, wherein said face recognition and said marking said target face images are implemented by executing a specific program with a single chip controller or computer or remote server.

7. The method as claimed in claim 1, wherein said face recognition data further comprises a strict level for said face recognition to distinguish different levels of strictness desired or to select all or part of said face recognition data to display.

8. The method as claimed in claim 3, wherein said face recognition data further comprises a strict level for said face recognition to distinguish different levels of strictness desired or to select all or part of said face recognition data to display.

9. The method as claimed in claim 1, further comprising an alarm and/or tracking process after said marking said target face image, wherein said alarm process comprises a step of triggering an alarm, sending an e-mail, sending a message via a mobile phone, and/or make a call for informing some related people, and said tracking process comprises a step of tracking and marking a location of said target and/or mismatched face image through a platform with a surveillance program or a three-dimensional spatial model.
